(19) United States
(12) Patent Application Publication
(10) Pub. No.: US 2025/0340749 A1
(43) Pub. Date: Nov. 6, 2025

(54) AQUEOUS PIGMENT DISPERSION AND PRODUCTION METHOD FOR AQUEOUS PIGMENT DISPERSION

(71) Applicant: DIC Corporation, Tokyo (JP)

(72) Inventors: Yutaro Ueda, Kita-adachi-gun (JP); Ryota Hibino, Kita-adachi-gun (JP); Hideki Ganbayashi, Kita-adachi-gun (JP); Shinichi Okada, Kita-adachi-gun (JP)

(73) Assignee: DIC Corporation, Tokyo (JP)

(21) Appl. No.: 16/339,454

(22) PCT Filed: Oct. 26, 2017
(86) PCT No.: PCT/JP2017/038676

§ 371 Date: Apr. 4, 2019

(30) Foreign Application Priority Data
Nov. 10, 2016 (JP) 2016-219676

(51) Int. Cl. C09D 17/00; C09B 67/08; C09B 67/20

(52) U.S. Cl. CPC C09D 17/003; C09B 67/0013; C09B 67/006; C09D 17/001

(57) ABSTRACT

The problem to be solved by the present invention is to provide an aqueous pigment dispersion that can maintain superior dispersibility and long-term storage stability, and that can be used for producing printed matter superior in color development in printing on plain paper. The present invention relates to an aqueous pigment dispersion that contains a pigment including C.I. pigment red 150, a water soluble organic solvent, and a radical polymer having an aromatic ring structure or a heterocyclic structure and having an acid value of 50 to 120 mgKOH/g, acid groups in the radical polymer being partially or entirely neutralized with a basic compound, the radical polymer being contained at a mass ratio to the pigment in the range of 0.001 to 0.1.

### TECHNICAL FIELD

The present invention relates to an aqueous pigment dispersion containing C.I. pigment red 150 and a method of producing the same.

### BACKGROUND ART

Ink jet printers used for office applications are used in printing on various media. An example of such a medium whose consumption is particularly large is plain paper. Although there is surface-treated plain paper dedicated to ink jet printing, the consumption of such paper is smaller than that of inexpensive plain paper such as recycled paper because of the high cost.

Such plain paper generally easily absorbs inks. Thus, in printing by an ink jet printer, the density of the obtained printed matter tends to be low.

On the other hand, among pigments used in color inks for ink jet recording, C.I. pigment red 150 is often used in red-based (magenta, red) inks.

An example of a known ink for ink jet recording containing C.I. pigment red 150 is an aqueous ink jet ink composition at least containing two azo pigments as coloring ingredients, a pigment dispersing resin, water, and a water soluble solvent, the content of the following general formula (1) which is one component of the two azo pigments in the ink being 400 ppm or less, the water soluble solvent being at least one selected from a glycol ether and a diol (see, for example, PTL 1).

However, in view of an industrial requirement for printed matter that is highly clear and is further superior in color development even on plain paper, any of conventional inks may be just one step short of the required performance in terms of the color development. In addition, conventional inks may be decreased in dispersion stability of pigments with time, which is concern in some cases, for example, in increasing the volume of the ink tank.

### CITATION LIST

### Patent Literature

PTL 1: JP-A-2012-184334

### SUMMARY OF INVENTION

### Technical Problem

The problem to be solved by the present invention is to provide an aqueous pigment dispersion that has superior dispersibility and long-term storage stability, and can be used for production of printed matter superior in color development in printing on plain paper.

### Solution to Problem

The present inventors intensively studied on the following assumption: it should be effective for achieving good color development on plain paper to quickly reduce pigment dispersibility immediately after impact of an ink on a paper to thus reduce the rate of penetration of a pigment, thereby fixing the pigment in a part of the paper that is as shallow as possible (a part closer to the surface that the ink impacted).

The color development may greatly vary depending on the type and amount of the pigment used. With the fact taken into account, the present inventors have found that, in the case of using a certain pigment, C.I. pigment red 150, the above problem can be solved by setting the mass ratio of the pigment dispersing resin to the total amount of the pigment including the C.I. pigment red 150 within a certain range.

On the other hand, in a widely known conventional aqueous pigment dispersion, the mass ratio of the pigment dispersing resin to the pigment is set to 10% by mass or more in order to maintain good dispersibility and storage stability.

However, when the mass ratio of the pigment dispersing resin to the total amount of the C.I. pigment red 150 was set within a certain range as described above for further improving the color development, significant reduction of the dispersibility and storage stability has sometimes been caused.

Thus, the present inventors have found that, in the use of a certain pigment, C.I. pigment red 150, an aqueous pigment dispersion obtained by the following manner has superior dispersibility and storage stability and can be used for production of an ink having superior color development on plain paper: the aqueous pigment dispersion is obtained by selecting a radical polymer having an aromatic ring structure or a heterocyclic structure and having an acid value of 50 to 120 mgKOH/g as a pigment dispersing resin, and setting the mass ratio of the radical polymer to the total amount of a pigment including the C.I. pigment red 150 in the range of 0.001 to 0.1.

Specifically, the present invention relates to an aqueous pigment dispersion containing a pigment including C.I. pigment red 150, a water soluble organic solvent, and a radical polymer having an aromatic ring structure or a heterocyclic structure and having an acid value of 50 to 120 mgKOH/g, acid groups in the radical polymer being partially or entirely neutralized with a basic compound, the radical polymer being contained at a mass ratio to the pigment in the range of 0.001 to 0.1.

Furthermore, the present invention relates to a method of producing an aqueous pigment dispersion, the method including: producing a kneaded mixture that contains a pigment including C.I. pigment red 150, a basic compound, a water soluble organic solvent, and a radical polymer having an aromatic ring structure or a heterocyclic structure and having an acid value of 50 to 120 mgKOH/g at a mass ratio of the radical polymer to the total amount of the pigment in the range of 0.001 to 0.1; and mixing the kneaded mixture with water.

### Advantageous Effects of Invention

The aqueous pigment dispersion of the present invention can maintain superior dispersibility and storage stability, and can be used for production of an ink that can be used for production of printed matter superior in color development in printing on plain paper.

### DESCRIPTION OF EMBODIMENTS

The aqueous pigment dispersion of the present invention is an aqueous pigment dispersion containing a pigment including C.I. pigment red 150, a water soluble organic solvent, and a radical polymer having an aromatic ring structure or a heterocyclic structure and having an acid value of 50 to 120 mgKOH/g, acid groups in the radical polymer being partially or entirely neutralized with a basic compound, the radical polymer being contained at a mass ratio to the total amount of the pigment in the range of 0.001 to 0.1.

Here, the aqueous pigment dispersion refers to a dispersion in a state where a pigment is dispersed in a solvent, such as water. The aqueous pigment dispersion sometimes refers to a material that is used in producing an aqueous pigment ink, or an aqueous pigment ink itself.

In the aqueous pigment dispersion of the present invention, a pigment including C.I. pigment red 150 is used. The content of the pigment can be appropriately selected in the range where the mass ratio of the radical polymer to the total amount of the pigment is 0.001 to 0.1, and for providing an aqueous pigment dispersion having further superior dispersibility and storage stability and having superior color development on plain paper, the pigment is preferably used at a content to give such a mass ratio in the range of 0.01 to 0.1, and more preferably in the range of 0.04 to 0.1.

It is believed that, in an aqueous pigment dispersion having a mass ratio of the radical polymer to the total amount of the pigment in the above range, because of the small amount of the radical polymer used relative to the pigment, the aqueous pigment dispersion has good dispersion stability in water but the pigment dispersed by the radical polymer is likely to be quickly aggregated by a large impact applied when the ink impacts paper. It is supposed that the aggregated pigment hardly penetrates inside the paper but easily fixes in the vicinity of the surface of the plain paper, resulting in increase of the color development.

On the other hand, with a mass ratio of the radical polymer to the total amount of the pigment exceeding the above range, the dispersion stability of the aqueous pigment dispersion tends to significantly deteriorate. The reason has not been elucidated, but aggregation of the increased amount of the radical polymer that is not adsorbed on the pigment is considered as a factor.

### (Pigment Containing C.I. Pigment Red 150)

In the present invention, C.I. pigment red 150 as the pigment is used as an essential component.

As the C.I. pigment red 150, a conventionally known one can be used.

The C.I. pigment red 150 to be used preferably has a primary particle size of 1 μm or less, and more preferably 10 nm to 250 nm, and particularly preferably 50 nm to 200 nm. Note that, as the primary particle size, for example, a mean particle size measured with a scanning electron microscope (SEM) can be adopted.

The C.I. pigment red 150 is preferably used in an amount of 5% by mass or more based on the total amount of the pigment, more preferably in an amount of 10% by mass or more, further preferably in an amount of 20% by mass or more, and for providing an aqueous pigment dispersion having further superior dispersion stability and capable of forming printed matter superior in color development, particularly preferably used in an amount in the range of 30% by mass to 100% by mass.

Furthermore, in the present invention, in addition to the C.I. pigment red 150, another pigment can be used as the pigment in combination therewith as needed.

Examples of such another pigment include: a monoazo lake pigment, such as C.I. pigment red 193; a disazo pigment, such as 38; naphthol AS pigments, such as 2, 5, 8, 9, 10, 11, 12, 14, 15, 16, 17, 18, 22, 23, 31, 32, 112, 114, 146, 147, 170, 184, 187, 188, 210, 213, 238, 245, 253, 256, 258, 266, 268, and 269; β-naphthol pigments, such as 3, 4, and 6; β-naphthol lake pigments, such as 49, 53, and 68; naphthol AS lake pigments, such as 237, 239, and 247; condensed azo pigments, such as 144, 166, 214, 220, 221, 242, and 262; benzimidazolon pigments, such as 171, 175, 176, 185, and 208; a dimethylquinacridone pigment, such as 122; dichloroquinacridone pigments, such as 202 and 209; an unsubstituted quinacridone, such as pigment violet 19; and mixtures or solid solutions of at least two or more selected from the above pigments.

### (Radical Polymer)

In the aqueous pigment dispersion of the present invention, a radical polymer that has an aromatic ring structure or a heterocyclic structure and has an acid value of 50 to 120 mgKOH/g in which the acid groups are partially or entirely neutralized with a basic compound (neutralized polymer) is used. As such a radical polymer, one that acts as a dispersing resin of the pigment including C.I. pigment red 150 can be used. This can provide an aqueous pigment dispersion having further superior dispersion stability for a long period of time and having superior color development on plain paper.

Examples of the aromatic ring structures or heterocyclic structures include ring structures that are introduced into the radical polymer by using a monomer having an aromatic ring structure or a monomer having a heterocyclic structure as described later.

As the ring structure, a benzene ring structure is preferably used and a styrene-derived ring structure is more preferably used.

The aromatic ring structure or heterocyclic structure can increase the hydrophobicity of the radical polymer to improve the adsorption onto the pigment.

As the radical polymer, one having an acid value of 50 to 120 mgKOH/g is used. The acid value is an acid value attributable to acid groups, such as a carboxyl group, a sulfonate group, and a phosphate group

The acid value is preferably in the range of 70 to 120 mgKOH/g, and for further increasing the dispersibility and storage stability and further increasing the color development in printing on plain paper, the acid value is more preferably in the range of 90 to 120 mgKOH/g.

Note that the acid value is a numerical value that is measured according to the Japan Industrial Standards Committee “K0070:1992: Testing Method of Acid Value, Saponification Value, Ester Value, Iodine value, Hydroxyl Value and Unsaponifiable Matter of Chemical Products”, and is an amount (mg) of potassium hydroxide required to neutralize 1 g of a radical polymer.

When the radical polymer used is dissolved or dispersed in water, the acid groups in the radical polymer are partially or entirely neutralized with a basic compound as described later (neutralized polymer). This can further increase the dispersibility and storage stability.

As the radical polymer, polymers obtained by polymerizing various monomers by radical polymerization can be used.

As the monomer, a monomer having an aromatic ring structure can be used when an aromatic ring structure is to be introduced in the radical polymer and a monomer having a heterocyclic structure can be used when a heterocyclic structure is to be introduced therein.

As the monomer having an aromatic ring structure, for example, styrene, p-tert-butyldimethylsiloxystyrene, o-methylstyrene, p-methylstyrene, p-tert-butylstyrene, p-tert-butoxystyrene, m-tert-butoxystyrene, p-tert-(l-ethoxymethyl) styrene, m-chlorostyrene, p-chlorostyrene, p-fluorostyrene, α-methylstyrene, p-methyl-α-methylstyrene, vinylnaphthalene, or vinylanthracene can be used.

As the monomer having a heterocyclic structure, for example, a vinylpyridine-based monomer, such as 2-vinylpyridine or 4-vinylpyridine, can be used.

When a radical polymer having both of an aromatic ring structure and a heterocyclic structure is used as the radical polymer, a monomer having an aromatic ring structure and a monomer having a heterocyclic structure can be used in combination as the monomer.

Since a radical polymer having an aromatic ring structure is preferably used as the radical polymer, a monomer having an aromatic ring structure is also preferably used as the monomer, and styrene, α-methylstyrene, or tert-butylstyrene is more preferably used.

The monomer having an aromatic ring structure or a heterocyclic structure is preferably used in an amount in the range of 60 to 95% by mass based on the total amount of the monomers for further improving the adsorption onto the pigment.

A radical polymer in which the monomer having an aromatic ring structure or a heterocyclic structure is used in a proportion of 60% by mass or more is easily adsorbed on the pigment, such as C.I. pigment red 150, and therefore can further increase the dispersibility and storage stability of the resulting aqueous pigment dispersion.

In addition, an aqueous ink for ink jet recording obtained by using the aqueous pigment dispersion tends to be superior in printing characteristics on plain paper and provides high image recording density (color development), and also tends to provide good waterproofness.

A radical polymer having a content of a monomer having an aromatic ring or a hetero ring of 95% by mass or less can maintain good dispersibility of the C.I. pigment red 150 coated with the radical polymer in an aqueous medium, and can increase the dispersibility and dispersion stability of a pigment in the aqueous pigment dispersion.

The radical polymer in which the monomer having an aromatic ring structure or a heterocyclic structure is used in an amount of 60 to 95% by mass based on the total amount of the monomers is a polymer having very high hydrophobicity. A radical polymer having high hydrophobicity has high affinity to the pigment surface in water. It is supposed that this leads to an increased amount of the radical polymer that is adsorbed on a pigment and a reduced amount of the excess radical polymer that is not adsorbed on a pigment.

In addition, for producing a radical polymer having an acid value in the certain range as the radical polymer, a monomer having an acid group can be used as the monomer.

As the monomer having an acid group, for example, a monomer having an anionic group, such as a carboxyl group, a sulfonate group, or a phosphate group, can be used.

As the monomer having an anionic group, a monomer having a carboxyl group is preferably used in terms of availability and obtaining an aqueous pigment dispersion having further superior pigment dispersion stability. Acrylic acid or methacrylic acid is more preferably used.

The monomer having an acid group is preferably used in an amount in the range of 5 to 20% by mass based on the total amount of the monomers used in production of the radical polymer for obtaining a radical polymer having an acid value in the aforementioned certain range.

In addition, as a monomer usable in production of the radical polymer, in addition to those mentioned above, another monomer can be used as needed.

As such another monomer, for example, methyl (meth)acrylate, n-propyl (meth)acrylate, isopropyl (meth)acrylate, n-butyl (meth)acrylate, sec-butyl (meth)acrylate, tert-butyl (meth)acrylate, 2-ethylbutyl (meth)acrylate, 1,3-dimethylbutyl (meth)acrylate, hexyl (meth)acrylate, 2-ethylhexyl (meth)acrylate, octyl (meth)acrylate, ethyl (meth)acrylate, n-butyl (meth)acrylate, 2-methylbutyl (meth)acrylate, pentyl (meth)acrylate, heptyl (meth)acrylate, nonyl (meth)acrylate, 3-ethoxypropyl (meth)acrylate, 3-ethoxybutyl (meth)acrylate, dimethylaminoethyl (meth)acrylate, 2-hydroxyethyl (meth)acrylate, 2-hydroxybutyl (meth)acrylate, ethyl-α-(hydroxymethyl) (meth)acrylate, dimethylaminoethyl (meth)acrylate, hydroxyethyl (meth)acrylate, hydroxypropyl (meth)acrylate, phenyl (meth)acrylate, benzyl (meth)acrylate, phenylethyl (meth)acrylate, diethylene glycol (meth)acrylate, triethylene glycol (meth)acrylate, polyethylene glycol (meth)acrylate, glycerol (meth)acrylate, bisphenol A (meth)acrylate, dimethyl maleate, diethyl maleate, and vinyl acetate may be used alone or in combination of two or more thereof. Note that the “(meth)acrylate” refers to acrylate or methacrylate.

In addition, as the radical polymer, a polymer in which the structure formed by radical polymerization of the monomer is linear, a polymer having a grafted structure, or a polymer having a crosslinked structure can be used. In each polymer, the arrangement of monomers is not limited, and a polymer having a random arrangement or a polymer having a block arrangement can be used.

The polymer having a crosslinked structure can be produced by using a monomer having a crosslinkable functional group as the monomer.

As the monomer having a crosslinkable functional group, for example, a polyhydric alcohol poly(meth)acrylate, such as ethylene glycol di(meth)acrylate, propylene glycol di(meth)acrylate, polyethylene glycol di(meth)acrylate, poly(oxyethylene oxypropylene)glycol di(meth)acrylate, or a tri(meth)acrylate of a glycerol alkylene oxide adduct; glycidyl (meth)acrylate, or divinylbenzene can be used.

As the radical polymer for use in the present invention, a polymer constituted only of a monomer having an acid group and a monomer having an aromatic ring structure or a heterocyclic structure is preferably used.

As the radical polymer for use in the present invention, among the aforementioned polymers, a polymer having a styrene structural unit and a (meth)acrylic acid structural unit that has an acid value in the certain range, such as a styrene-(meth)acrylic acid polymer or a styrene-(meth)acrylate ester-(meth)acrylic acid polymer, is preferably used for obtaining an aqueous pigment dispersion having further superior dispersibility and storage stability and capable of forming printed matter superior in the color development.

As the styrene-(meth)acrylic acid polymer, any of a styrene-acrylic acid polymer, a styrene-methacrylic acid polymer, and a styrene-acrylic acid-methacrylic acid polymer can be used, but a styrene-acrylic acid-methacrylic acid polymer is preferably used since the co-polymerizability of the monomers is increased to increase the uniformity of the polymer, resulting in provision of a pigment dispersion more superior in the dispersibility and storage stability.

In the radical polymer used, a total amount of styrene, acrylic acid, and methacrylic acid is preferably 80% by mass or more, more preferably 85% by mass or more, and further preferably 90% by mass to 100% by mass, based on the total amount of the monomers used in the production thereof.

Note that, in the present invention, the radical polymerization ratios (reaction ratios) of the monomers are considered to be substantially the same, and the ratio of the monomers used (charging ratio) is considered to be the same as the ratio of the structural units derived from the monomers constituting the radical polymer.

Examples of methods of producing the radical polymer from the monomers by a radical polymerization method include a bulk polymerization method, a solution polymerization method, a suspension polymerization method, and an emulsion polymerization method. Here, a commonly known polymerization initiator, chain transfer agent (polymerization degree adjuster), surfactant, and defoaming agent can be used as needed.

Examples of polymerization initiators include 2,2′-azobis (2,4-dimethylvaleronitrile), 2,2′-azobisisobutyronitrile, 1,1′-azobis (cyclohexane-1-carbonitrile), benzoylperoxide, dibutylperoxide, and butylperoxybenzoate. The polymerization initiator is preferably used in an amount in the range of 0.1 to 10% by mass based on the total amount of the monomers used in the production of the radical polymer.

As the radical polymer, any of a linear polymer and a graft polymer can be used. When the styrene-(meth)acrylic acid polymer is used as the radical polymer, an example of the graft polymer is a graft copolymer that is composed of a branched chain or a main chain constituted of a copolymer of monomers including (meth)acrylic acid and/or styrene, and a hydrophobic side chain, such as polystyrene, an alkylene oxide chain, such as epoxy, ethylene oxide, or propylene oxide, bisphenol, or a long chain alkyl. As the styrene-(meth)acrylic acid polymer, a mixture of the graft polymer and a linear polymer may be used.

The weight average molecular weight of the radical polymer used is preferably in the range of 2,000 to 40,000, more preferably in the range of 5,000 to 20,000, and particularly preferably in the range of 7,000 to 15,000.

When a radical polymer having a weight average molecular weight of 2,000 or more is used, the long-term storage stability of the aqueous pigment dispersion tends to be increased, and sedimentation of pigment due to aggregation and the like tends not to occur. In addition, when a styrene-(meth)acrylic acid polymer having a weight average molecular weight of 30,000 or less is used, the ejection stability of the ink for ink jet recording tends to be increased. Note that the weight average molecular weight is a value obtained by measurement by GPC (gel permeation chromatography), followed by conversion in terms of the molecular weight of a polystyrene used as a standard substance.

### (Basic Compound)

The acid groups in the radical polymer are neutralized with a basic compound as described above.

Examples of basic compounds that can be used include: inorganic basic compounds, such as a hydroxide of an alkali metal, for example, potassium or sodium, a carbonate of an alkali metal, for example, potassium or sodium, a carbonate of an alkali earth metal, for example, calcium or barium, and ammonium hydroxide; and organic basic compounds, such as amino alcohols, for example, triethanol amine, N, N-dimethanol amine, N-aminoethylethanol amine, dimethylethanol amine, and N—N-butyldiethanol amine, morpholines, for example, morpholine, N-methylmorpholine, and N-ethylmorpholine, and piperazines, for example, N-(2-hydroxyethyl) piperazine and piperazine hexahydrate. Among them, as the basic compound, an alkali metal hydroxide, such as potassium hydroxide, sodium hydroxide, or lithium hydroxide, is preferably used for contributing to reduction of viscosity of the aqueous pigment dispersion to further increase storage stability and ejection stability of the ink for ink jet recording, and potassium hydroxide is particularly preferably used.

The rate of neutralization of the anionic groups with such a basic compound is not limited, but for suppressing production of aggregation by the unneutralized radical polymer, the rate of neutralization is generally preferably 80 to 120%. In the present invention, the rate of neutralization refers to a value calculated by the following formula.

Rate of neutralization (%)=[{mass of basic compound (g)*56.11×1000}/{acid value of radical polymer (mgKOH/g)×equivalent of basic compound×mass of radical polymer (g)}]×100

The basic compound may be dissolved or dispersed in a solvent, such as water, in advance when the basic compound is mixed with the pigment and the like.

### (Water Soluble Organic Solvent)

As the water soluble organic solvent for use in the present invention, one known as a wetting agent can be used, and examples thereof include ketones, such as acetone, methyl ethyl ketone, methyl butyl ketone, and methyl isobutyl ketone; alcohols, such as methanol, ethanol, 2-propanol, 2-methyl-1-propanol, 1-butanol, and 2-methoxyethanol; ethers, such as tetrahydrofuran, 1,4-dioxane, and 1,2-dimethoxyethanes; and amides, such as dimethylformamide and N-methylpyrrolidone. In particular, a compound selected from ketones having 3 to 6 carbon atoms and alcohols having 1 to 5 carbon atoms is preferably used.

Examples of such water soluble organic solvents that can be used include glycols having high viscosity, such as ethylene glycol, diethylene glycol, triethylene glycol, tetraethylene glycol, propylene glycol, polyethylene glycol, and polypropylene glycol; diols, such as butanediol, pentanediol, hexanediol, and similar diols thereto; a glycol ester, such as propylene glycol laurate; glycol ethers such as cellosolve, including diethylene glycol monoethyl ether, diethylene glycol monobutyl ether, diethylene glycol monohexyl ether, propylene glycol ether, dipropylene glycol ether, and triethylene glycol ether; alcohols, such as methanol, ethanol, isopropyl alcohol, 1-propanol, 2-propanol, 1-butanol, 2-butanol, butyl alcohol, pentyl alcohol, and similar alcohols thereto; sulfolane; a lactone, such as γ-butyrolactone; a lactam, such as N-(2-hydroxyethyl) pyrrolidone; glycerol and derivatives thereof, and polyoxyethylene benzyl alcohol ether.

One of the water soluble organic solvents may be used or two or more thereof can be used in combination. Among them, as the water soluble organic solvent, a polyhydric alcohol, such as a glycol or a diol which has high boiling point, low volatility, and high surface tension, is preferably used, and a glycol, such as diethylene glycol or triethylene glycol, is particularly preferably used.

### (Water)

In the aqueous pigment dispersion of the present invention, the components as described above are dissolved or dispersed in water. As the water, pure water, such as ion exchange water, ultrafiltrated water, reverse osmotic water, or distilled water, or ultrapure water can be used. In addition, as the water, water sterilized by ultraviolet irradiation or addition of hydrogen peroxide is suitably used since mould or bacteria generation can be prevented when the aqueous pigment dispersion or an ink produced using the same is stored for a long period of time.

### (Method of Producing Aqueous Pigment Dispersion)

The method of producing an aqueous pigment dispersion of the present invention includes: producing a kneaded mixture that contains a pigment including C.I. pigment red 150, a basic compound, a water soluble organic solvent, and a radical polymer having an aromatic ring structure or a heterocyclic structure and having an acid value of 50 to 120 mgKOH/g at a mass ratio of the radical polymer to the total amount of the pigment in the range of 0.001 to 0.1; and mixing the kneaded mixture with water.

First, the pigment including C.I. pigment red 150, the basic compound, the water soluble organic solvent, and the radical polymer are supplied so as to give the above mass ratio into a container to produce a kneaded mixture. The step of producing the kneaded mixture can be performed by any known dispersion method with no limitation. Examples thereof include a media mill dispersing method with media using a paint shaker, a bead mill, a sand mill, a ball mill, or the like; and a media-less dispersion method using an ultrasonic homogenizer, a high pressure homogenizer, a Nanomizer, a Ultimizer, or the like; and a kneading dispersion method, using a roll mill, a Henschel mixer, a pressure kneader, an intensive mixer, a Bunbury mixer, a planetary mixer, or the like. Among them, a kneading dispersion method is a method of reducing the size of pigment particles by providing a strong share force with a kneader to a mixture that contains a pigment and has a high solid concentration. The method can provide a kneaded mixture having a high pigment concentration, and is effective for reducing coarse particles. Such a method is thus preferred. In the kneading dispersion method, water is preferably contained in 50% by mass or less based on the entire solid in the mixture, or water is preferably not contained.

In the kneading dispersion method, a mixture of the pigment including C.I. pigment red 150, the basic compound, the water soluble organic solvent, and the radical polymer is kneaded. The order of putting the components of the mixture is not limited, and the whole amounts may be put at once and then the kneading is started, or the components may each be put portionwise. The order of putting may be changed depending on the raw materials: for example, the radical polymer, the basic compound, and the pigment may be put first and then the water soluble organic solvent may be put. The amounts of the raw materials put can be in the above range. In blending the basic compound, when an aqueous basic compound solution obtained by previously dissolving the basic compound in water is used, the amount of water in the mixture is preferably determined in view of the amount of water to be contained in the aqueous basic compound solution.

For providing strong share force which is an advantageous point of the kneading dispersion method to the mixture, the mixture is preferably kneaded at a high solid content in the mixture since higher share force can thus be given to the mixture. The solid content is preferably in the range of 20 to 100% by mass, and more preferably in the range of 30 to 90% by mass. The solid content is particularly preferably in the range of 40 to 80% by mass since the viscosity of the mixture in kneading is kept at an appropriately high level and thereby the load on the mixture can be increased by the kneader, resulting in sufficient crush of the pigment in the mixture and efficient adsorption of the radical polymer on the pigment (coating of the pigment with the radical polymer).

The temperature in kneading can be appropriately controlled in view of the temperature characteristics, such as glass transition point, of the radical copolymer used, so that a sufficient share force is added to the kneaded mixture. For example, when the radical polymer is: the styrene-(meth)acrylic acid polymer, kneading is preferably performed at a temperature that is lower than the glass transition point but whose difference from the glass transition point is less than 50 degrees. When kneading is performed in such a temperature range, there arises no deficient share force due to reduced viscosity of the kneaded mixture which is caused by melting of the radical polymer by increase of the kneading temperature.

As the kneading apparatus for use in the kneading step, any one can be selected from such known kneading apparatuses as described above as long as it can generate high share force on the mixture having a high solid content. As the kneading apparatus, a kneading apparatus with a sealable mixing vessel and a stirring blade is preferably used rather than an open-type kneader having no mixing vessel, such as a two-roll kneader.

Examples of kneading apparatuses with a sealable mixing vessel and a stirring blade include a Henschel mixer, a pressure kneader, a Banbury mixer, and a planetary mixer, and a planetary mixer or the like is particularly preferably used.

In the present invention, kneading is preferably performed at a high concentration of solid which is constituted of the pigment and the radical polymer, and the viscosity varies in a wide range depending on the state of the kneaded mixture. As compared with a two-roll kneader or the like, a planetary mixer can achieve kneading at viscosities in a wider range and the viscosity and loaded share force in kneading can be controlled more easily by addition of an aqueous medium and distillation at reduced pressure.

When a kneading apparatus with a sealable mixing vessel and a stirring blade is used, the kneaded mixture can be dispersed in water by supplying water or a water soluble organic solvent in the kneading apparatus after the kneading.

As the aqueous pigment dispersion obtained by the method, one having a pigment concentration of 10 to 50% by mass is preferably used since dilution with water or the like is easily performed in production of an ink.

In addition, in this method, when inconvenience is caused in handling due to a higher viscosity than the above range in spite of a pigment concentration in the aforementioned range, the aqueous pigment dispersion can be appropriately diluted with an aqueous medium to make an aqueous pigment dispersion having a viscosity within a desired range.

Specifically, the aqueous pigment dispersion can be produced, for example, in the following manner: after a pigment kneaded mixture is produced with a kneader having a mixing vessel as described above, an aqueous medium is added in the mixing vessel and the mixture is mixed and stirred as needed to directly dilute the mixture. Alternatively, the aqueous pigment dispersion can be prepared by mixing a solid pigment dispersion and an aqueous medium with another stirrer having a stirring blade, and stirring the mixture as needed.

With respect to the mixing of the aqueous medium, an amount of the aqueous medium needed may be mixed with the pigment kneaded mixture at once, or the amount needed may be added continuously or intermittently while mixing. The latter method enables effective dilution with the aqueous medium, making it possible to produce the aqueous pigment dispersion in a shorter period of time.

As the aqueous pigment dispersion, one subjected to a dispersion treatment with a disperser after production may be used.

Examples of dispersers include a paint shaker, a bead mill, a roll mill, a sand mill, a ball mill, an attritor, a basket mill, a sand mill, a sand grinder, DYNO MILL, DISPERMAT, an SC mill, a spike mill, an agitator mill, a juice mixer, a high pressure homogenizer, an ultrasonic homogenizer, a Nanomizer, a dissolver, a Disper, a high speed impeller disperser, a kneader, and a planetary mixer.

The volume average particle size of the particles contained in the aqueous pigment dispersion is preferably 50 nm to 300 nm, and for providing superior dispersibility and storage stability and forming printed matter superior in color development, the volume average particle size is most preferably 100 nm to 200 nm.

### (Aqueous Ink for Ink Jet Recording)

The ink can be used for a paint for cars and building materials, an ink for printing, such as an offset ink, a gravure ink, a flexographic ink, or a silkscreen ink, or an ink for ink jet recording.

The ink can be produced by mixing the aqueous pigment dispersion with water, a water soluble organic solvent, an additive, or the like as needed, and stirring the mixture as needed. In producing the ink, centrifugation or ultrafiltration may be performed, as needed, during the stirring or after production of the ink. The ink is preferably diluted into a pigment concentration of about 0.1 to 20% by mass.

As the additive, a resin used as a binder, such as an acrylic resin or a polyurethane resin, a drying inhibitor, a penetrant, a surfactant, or the like can be used.

The drying inhibitor can be used for the purpose of preventing drying of the ink, for example, in a printer head. The drying inhibitor is preferably contained in the range of 3% by mass to 50% by mass based on the total amount of the ink.

As the drying inhibitor, the same substance as the water soluble organic solvent can be used, and one that is miscible with water and can provide a clogging prevention effect of a head of an ink jet printer is preferred.

Examples of such drying prevention agents include glycerol, ethylene glycol, diethylene glycol, triethylene glycol, triethylene glycol mono-n-butyl ether, polyethylene glycol having a molecular weight of 2000 or less, propylene glycol, dipropylene glycol, tripropylene glycol, 1,3-propylene glycol, isopropylene glycol, isobutylene glycol, 1,4-butanediol, 1,3-butanediol, 1,5-pentanediol, 1,6-hexanediol, mesoerythritol, and pentaerythritol. Among them, the use of glycerol or triethylene glycol as the drying preventer is highly safety, can further effectively prevent the drying of the ink, and can further increase the ejection property of the ink.

The penetrant can be used for improving penetration into a recording medium or adjusting the diameter of ink dots on a recording medium.

Examples of penetrants include lower alcohols, such as ethanol and isopropyl alcohol; and alkyl alcohol glycol mono ethers, such as ethylene glycol hexyl ether, diethylene glycol butyl ether, and propylene glycol propyl ether. The content of the penetrant in the ink is preferably 0.01% by mass to 10% by mass.

The surfactant can be used for controlling ink characteristics, such as surface tension. The surfactant is not limited, and examples include various anionic surfactants, nonionic surfactants, cationic surfactant, and amphoteric surfactants, and among them, anionic surfactants and nonionic surfactants are preferred.

Examples of anionic surfactants include alkylbenzene sulfonate salts, alkylphenyl sulfonate salts, alkylnaphthalene sulfonate salts, higher fatty acid salts, higher fatty acid ester sulfate ester salts, higher fatty acid ester sulfonate salts, higher alcohol ether sulfate ester salts and sulfonate salts, higher alkyl sulfosuccinate salts, polyoxyethylene alkyl ether carboxylate salts, polyoxyethylene alkyl ether sulfate salts, alkyl phosphate salts, and polyoxyethylene alkyl ether phosphate salts. Specific examples thereof include dodecylbenzene sulfonate salt, isopropylnaphthalene sulfonate salt, monobutylphenylphenol monosulfonate salt, monobutylbiphenyl sulfonate salt, and dibutylphenylphenol disulfonate salt.

Examples of nonionic surfactants include polyoxyethylene alkyl ethers, polyoxyethylene alkylphenyl ethers, polyoxyethylene fatty acid esters, sorbitan fatty acid esters, polyoxyethylene sorbitan fatty acid esters, polyoxyethylene sorbitol fatty acid esters, glycerol fatty acid esters, polyoxyethylene glycerol fatty acid esters, polyglycerol fatty acid esters, saccharide fatty acid esters, polyoxyethylene alkyl amine, polyoxyethylene fatty acid amide, fatty acid alkylol amide, alkyl alkanol amide, acetylene glycol, acetylene glycol oxyethylene adducts, and polyethylene glycol-polypropylene glycol block copolymers. Among them, polyoxyethylene nonylphenyl ether, polyoxyethylene octylphenyl ether, polyoxyethylene dodecylphenyl ether, polyoxyethylene alkyl ethers, polyoxyethylene fatty acid esters, sorbitan fatty acid esters, polyoxyethylene sorbitan fatty acid esters, fatty acid alkylol amides, acetylene glycol, acetylene glycol oxyethylene adducts, and polyethylene glycol-polypropylene glycol block copolymers are preferred.

As another surfactant, a silicone surfactant, such as a polysiloxane oxyethylene adduct; a fluorosurfactant, such as a perfluoroalkyl carboxylate salt, a perfluoroalkyl sulfonate salt, or an oxyethylene perfluoroalkyl ether; or a biosurfactant, such as spiculisporic acid, rhamnolipid, or lysolecithin can be used.

As the surfactant, one surfactant may be used alone or two or more surfactants may be used in combination. The amount of the surfactant used is preferably 0.001% by mass to 2% by mass based on the mass of the entire ink, more preferably 0.001% by mass to 1.5% by mass, and for preventing blur or the like of a printing image more effectively, the amount is further preferably in the range of 0.01% by mass to 1% by mass.

As such another additive, a preservative, a viscosity modifier, a pH modifier, a chelating agent, a plasticizer, an antioxidant, or a UV absorber can be used as needed.

### (Recording Medium)

The recording medium for the aqueous ink for ink jet recording is not limited, and examples include an absorbable recording medium, such as a copy paper (PPC paper) commonly used for a copier, a recording medium having an ink absorbing layer, a non-water absorbable recording medium having no ink absorbability, and a slightly absorbable recording medium having low ink water absorbability.

Examples of absorbable recording media include a plain paper, an ink jet-dedicated plain paper, such as an ink jet-dedicated plain paper having a cationic component on the surface thereof, a fabric, a cardboard, and a wood. An example of recording medium having an absorbing layer is an ink jet-dedicated paper, and specific examples thereof include Pictorico Pro Photopaper from Pictorico and Professional Photo Paper from Epson.

As the non-water absorbable recording medium having no ink absorbability, for example, one used in a food packaging material can be used, and any known plastic film can be used. Specific examples thereof include polyester films, such as polyethylene terephthalate and polyethylene naphthalate, polyolefin films, such as polyethylene and polypropylene, a polyamide film, such as nylon, polystyrene films, polyvinylalcohol films, polyvinyl chloride films, polycarbonate films, polyacrylonitrile films, and polylactic acid films. In particular, polyester films, polyolefin films, and polyamide film are preferred, and polyethylene terephthalate, polypropylene, and nylon are further preferred. Such a film that is coated with poly vinylidene chloride or the like for imparting barrier properties may be used, and a film in which a deposited layer of a metal, such as aluminum, or a metal oxide, such as silica or alumina, is laminated may be used together as needed.

The plastic film may be an unstretched film or may be a monoaxially- or biaxially-stretched film. The surface of the film may be untreated, but preferably treated by a corona discharging treatment, an ozone treatment, a low temperature plasma treatment, a flame treatment, a glow discharging treatment, or another treatment for enhancing the adhesion.

The thickness of the plastic film is appropriately changed depending on the use purpose, and, for example, in the case of use in a soft package, the thickness is preferably 10 μm to 100 μm for providing softness, durability, and carling resistant. The thickness is more preferably 10 μm to 30 μm. A specific example of a film having such a thickness is PYLEN (registered trade name) from TOYOBO Co., Ltd.

As a slightly absorbable recording medium having low ink water absorbability, an art paper such as an actual printing paper, a coated paper, a light weight coated paper, a fine coating paper, or the like can be used. The slightly absorbable recording medium is one obtained by coating the surface of a woodfree paper, a neutralized paper, or the like which mainly contains cellulose and whose surface is generally not treated, with a coating material to provide a coating layer. Examples thereof include fine coat papers, such as “OK Ever Light Coat” from Oji Paper Co. Ltd. and “Aurora S” from Nippon Paper Industries Co., Ltd., light weight coat papers (A3), such as “OK Coat L” from Oji Paper Co. Ltd. and “Aurora L” from Nippon Paper Industries Co., Ltd., coat papers (A2, B2), such as “OK Topcoat+” from Oji Paper Co. Ltd. and “Aurora Coat” from Nippon Paper Industries Co., Ltd., and art papers (A1), such as “OK Kanafuji+” from Oji Paper Co. Ltd. and “Tokubishi Art” from Mitsubishi Paper Mills Limited.

### EXAMPLES

The present invention will be described in more detail below with respect to examples.

### (Radical Polymer A)

Radical polymer A is a powder (1 mm or less diameter) produced by solution polymerization, which has a monomer constitution of styrene/acrylic acid/butyl acrylate at 90.40/9.50/0.10 (by mass), and has a weight average molecular weight of 8,000, an acid value of 70 mgKOH/g, and a glass transition temperature of 110° C.

### (Radical Polymer B)

Radical polymer B is a powder (1 mm or less diameter) produced by solution polymerization, which has a monomer constitution of styrene/acrylic acid at 87.70/12.30 (by mole), and has a weight average molecular weight of 11,000, an acid value of 90 mgKOH/g, and a glass transition temperature of 98° C.

### (Radical Polymer C)

Radical polymer C is a powder (1 mm or less diameter) produced by solution polymerization, which has a monomer constitution of styrene/acrylic acid at 87.70/12.30 (by mole), and has a weight average molecular weight of 9,000, an acid value of 90 mgKOH/g, and a glass transition temperature of 103° C.

### (Radical Polymer D)

Radical polymer D is a powder (1 mm or less diameter) produced by solution polymerization, which has a monomer constitution of styrene/acrylic acid/methacrylic acid at 83.00/7.35/9.55/0.10 (by mass), and has a weight average molecular weight of 11,000, an acid value of 120 mgKOH/g, and a glass transition temperature of 121° C.

### (Radical Polymer E)

Radical polymer E is a powder (1 mm or less diameter) produced by solution polymerization, which has a monomer constitution of styrene/acrylic acid/methacrylic acid/butyl acrylate at 72.00/12.13/15.77/0.10 (by mass), and has a weight average molecular weight of 8,000, an acid value of 180 mgKOH/g, and a glass transition temperature of 113° C.

### (Radical Polymer F)

Radical polymer F is a powder (1 mm or less diameter) produced by solution polymerization, which has a monomer constitution of styrene/acrylic acid/methacrylic acid/butyl acrylate at 56.00/19.09/24.81/0.10 (by mass), and has a weight average molecular weight of 6,000, an acid value of 280 mgKOH/g, and a glass transition temperature of 121° C.

Note that the weight average molecular weight in the present invention is a value obtained by converting a value measured by GPC (gel permeation chromatography) in terms of the molecular weight of a polystyrene used as a standard substance. Note that the measurement was performed by the following devices and conditions.
Liquid feeding pump: LC-9A
System controller: SLC-6B
Autoinjector: SIL-6B
Detector: RID-6A
   All from Shimadzu Corporation
Data processing software: Sic 480 II Data Station (from System Instruments, Co., Ltd.)
Column: GL-R400 (guard column)+GL-R440+GL-R450+GL-R400M (from Hitachi Chemical Co., Ltd.)
Eluent: THF (tetrahydrofuran)
Flow rate: 2 ml/min
Column temperature: 35° C.

### Example 1: Method of Producing Aqueous Pigment Dispersion

In a planetary mixer (trade name: Chemical Mixer ACM 04 LVTJ-B, from AICOHSHA MFG. Co., Ltd.), 2.0 parts by mass of the radical polymer A and 50 parts by mass of “FUJI FASTCARMINE 522-1 (from Fuji Pigment Co. Ltd.)” as C.I. pigment red 150 were put, followed by heating a jacket, and after the temperature of the content reached 80° C., the mixture was kneaded at a rotation number of 80 rpm and a revolution number of 25 rpm. After 5 minutes, 40 parts by mass of triethylene glycol and 0.41 parts by mass of a 34 mass % aqueous potassium hydroxide solution were added.

Kneading was continued up to 120 minutes after the point when the current value of the planetary mixer indicated the maximum current value to obtain a kneaded mixture. The ratio of the radical polymer to the pigment (R/P) was 0.04.

After 80 parts by mass of the obtained kneaded mixture was taken out of the jacket and was cut into 1-cm cubes, the cubes were placed into a commercially available juicer-mixer. After 80 parts by mass of ion exchange water was added thereto, the content was mixed by the juicer-mixer for 10 minute to perform dilution and dispersion into ion exchange water.

Ion exchange water and triethylene glycol were further added thereto to obtain an aqueous pigment dispersion having a pigment concentration of 14.5% by mass and a concentration of triethylene glycol based on the C.I. pigment red 150 of 100% by mass.

### (Method of Producing Aqueous Ink for Ink Jet Recording)

The obtained aqueous pigment dispersion was diluted with ion exchange water into a pigment concentration of 12% by mass to obtain a diluted dispersion.

Next, using the diluted dispersion, the following components were mixed to obtain an aqueous ink for ink jet recording having a pigment concentration of 6% by mass.
Diluted aqueous pigment dispersion: 50 parts by mass 2-Pyrrolidinon: 8 parts by mass
Triethylene glycol: 4 parts by mass
Triethylene glycol mono-n-butyl ether: 8 parts by mass
Purified glycerol: 3 parts by mass
SURFINOL 440 (from Air Products and Chemicals, Inc.): 0.5 parts by mass
Ion exchange water: 26.5 parts by mass

### Example 2

An aqueous pigment dispersion and an aqueous ink for ink jet recording were obtained in the same manner as in Example 1 except that 5.0 parts by mass of the radical polymer B was used in place of 2.0 parts by mass of the radical polymer A, and that the amount of the 34 mass % aqueous potassium hydroxide solution used was changed from 0.41 parts by mass to 1.32 parts by mass. The ratio of the radical polymer to the pigment (R/P) was 0.1.

### Example 3

An aqueous pigment dispersion and an aqueous ink for ink jet recording were obtained in the same manner as in Example 1 except that 5.0 parts by mass of the radical polymer C was used in place of 2.0 parts by mass of the radical polymer A, and that the amount of the 34 mass % aqueous potassium hydroxide solution used was changed from 0.41 parts by mass to 1.32 parts by mass. The ratio of the mass of the radical polymer to the mass of the pigment including C.I. pigment red 150 (R/P) was 0.1.

### Example 4

An aqueous pigment dispersion and an aqueous ink for ink jet recording were obtained in the same manner as in Example 1 except that 2.0 parts by mass of the radical polymer D was used in place of 2.0 parts by mass of the radical polymer A, and that the amount of the 34 mass % aqueous potassium hydroxide solution used was changed from 0.41 parts by mass to 0.71 parts by mass. The ratio of the mass of the radical polymer to the mass of the pigment including C.I. pigment red 150 (R/P) was 0.1.

### Comparative Example 1

An aqueous pigment dispersion and an aqueous ink for ink jet recording were obtained in the same manner as in Example 1 except that 10.0 parts by mass of the radical polymer B was used in place of 2.0 parts by mass of the radical polymer A, and that the amount of the 34 mass % aqueous potassium hydroxide solution used was changed from 0.41 parts by mass to 2.64 parts by mass. The ratio of the mass of the radical polymer to the mass of the pigment including C.I. pigment red 150 (R/P) was 0.2.

### Comparative Example 2

An aqueous pigment dispersion and an aqueous ink for ink jet recording were obtained in the same manner as in Example 1 except that 10.0 parts by mass of the radical polymer C was used in place of 2.0 parts by mass of the radical polymer A, and that the amount of the 34 mass % aqueous potassium hydroxide solution used was changed from 0.41 parts by mass to 2.64 parts by mass. The ratio of the mass of the radical polymer to the mass of the pigment including C.I. pigment red 150 (R/P) was 0.2.

### Comparative Example 3

An aqueous pigment dispersion and an aqueous ink for ink jet recording were obtained in the same manner as in Example 1 except that 10.0 parts by mass of the radical polymer D was used in place of 2.0 parts by mass of the radical polymer A, and that the amount of the 34 mass % aqueous potassium hydroxide solution used was changed from 0.41 parts by mass to 3.53 parts by mass. The ratio of the mass of the radical polymer to the mass of the pigment including C.I. pigment red 150 (R/P) was 0.2.

### Comparative Example 4

An aqueous pigment dispersion and an aqueous ink for ink jet recording were obtained in the same manner as in Example 1 except that 2.0 parts by mass of the radical polymer E was used in place of 2.0 parts by mass of the radical polymer A, and that the amount of the 34 mass % aqueous potassium hydroxide solution used was changed from 0.41 parts by mass to 1.05 parts by mass. The ratio of the mass of the radical polymer to the mass of the pigment including C.I. pigment red 150 (R/P) was 0.04.

### Comparative Example 5

An aqueous pigment dispersion and an aqueous ink for ink jet recording were obtained in the same manner as in Example 1 except that 2.0 parts by mass of the radical polymer F was used in place of 2.0 parts by mass of the radical polymer A, and that the amount of the 34 mass % aqueous potassium hydroxide solution used was changed from 0.41 parts by mass to 1.64 parts by mass. The ratio of the mass of the radical polymer to the mass of the pigment including C.I. pigment red 150 (R/P) was 0.04.

The evaluation of the aqueous pigment dispersions produced in Examples and Comparative Examples was performed by the following method.

### (Evaluation of Aqueous Pigment Dispersion)

### [Method of Measuring Volume Average Particle Size]

First, each of the aqueous pigment dispersions produced in Examples and Comparative Examples was diluted 1000-fold with ion exchange water.

Next, about 4 ml of the diluted aqueous pigment dispersion was placed in a cell, and the volume average particle size (MV) was measured by detecting scattered laser light using Nonotrack Particle Size Analyzer “UPA 150” from MicroTRAC Bell Corp. under a condition of 25° C.

The volume average particle size was measured three times and the average was calculated and round to two significant figures. The obtained value was taken as the volume average particle size (unit: nm).

### [Method of Measuring Number of Coarse Particles]

First, each of the aqueous pigment dispersions prepared in Examples and Comparative Examples was diluted with ion exchange water at any dilution factor within 500 to 1000.

Next, using a counting-type particle size analyzer (Accusizer 780 APS) from Particle Sizing Systems, the number of particles having a diameter of 0.5 μm or more contained in the diluted aqueous pigment dispersion was counted three times.

Next, the number of coarse particles per unit volume was calculated by multiplying each measurement value by the corresponding dilution factor. The average of the three numbers of coarse particles calculated in this manner was taken as the number of coarse particles in the aqueous pigment dispersion prepared in each of Examples and Comparative Examples.

### (Method of Testing Storage Stability of Aqueous Pigment Dispersion)

First, the volume average particle size of each of the aqueous pigment dispersions immediately after production in Examples and Comparative Examples was measured in the same manner as described in the [Method of measuring volume average particle size].

Next, each of the aqueous pigment dispersions obtained in Examples and Comparative Examples was sealed in a polypropylene container and was stored at 60° C. for 1 week, and then the volume average particle size thereof was measured in the same manner as in the [Method of measuring volume average particle size].

Next, the rate of change of the volume average particle size was calculated based on the volume average particle size of the aqueous pigment dispersion immediately after production, the volume average particle size of the aqueous pigment dispersion after storage, and the following formula: rate of change (%)=[(volume average particle size of aqueous pigment dispersion after storage-volume average particle size of aqueous pigment dispersion immediately after production)/volume average particle size of aqueous pigment dispersion immediately after production]×100. When the rate of change is 10% or less, the storage stability is determined as good.

### [Method of Measuring Printing Density]

First, an aqueous ink for ink jet recording which was allowed to stand 24 hours or more after production was charged in a commercially available ink jet printer cartridge, and a printing pattern was printed at an image density setting of 100% on a recycled paper (plain paper), an ink jet-dedicated paper (IJ-dedicated paper), and an OHP film.

Next, the printing pattern was subjected to colorimetry with “exact” from X-Rite Inc. to determine C* (chroma) of the printing pattern and calculate a value obtained by dividing C* by L* (lightness) (C*/L*).

Next, using “V-660” from JASCO, with the OHP film before printing taken as a blank, the absorbance (Abs.) at a wavelength of 570 nm on the printing surface of the OHP film after printing was measured and taken as an index of the quantity of ink impacted. Note that a higher absorbance at a wavelength of 570 nm means a larger quantity of ink ejected.

Next, an evaluation value of each of the aqueous inks for ink jet recording obtained in Examples and Comparative Examples was calculated based on the value (C*/L*), absorbance (Abs.), and the following formula: evaluation value=[value (C*/L*)/absorbance (Abs.)], and the printing density was evaluated based on the evaluation value.

Note that the evaluation value represents the printing density per unit quantity of ink ejected, and a higher evaluation value means that the color looks denser (higher evaluation).

Table 1 shows the results of evaluation of the aqueous pigment dispersions and aqueous inks for ink jet recording.

TABLE 1

| | Radical polymer | | | | | | Rate of change | | |
|---|---|---|---|---|---|---|---|---|---|
| | | | | Weight | Number of | Volume | in volume | | |
| | | | | average | coarse | average | average | (C*/L*)/(Abs) | |
| | | Acid | | molecular | particles | particle | particle | Recycled | IJ-dedicated |
| | Name | value | R/P | weight | (×10⁶/mL) | size (nm) | size (%) | paper | paper |
| Example 1 | A | 70 | 0.04 | 8,000 | 4,900 | 1.8 × 10² | 1% | 1.09 | 1.34 |
| Example 2 | B | 90 | 0.1 | 11,000 | 6,300 | 1.6 × 10² | −2% | 1.18 | 1.39 |
| Example 3 | C | 90 | 0.1 | 9,000 | 5,200 | 1.6 × 10² | −3% | 1.25 | 1.48 |
| Example 4 | D | 120 | 0.04 | 11,000 | 1,600 | 1.6 × 10² | 2% | 0.95 | 1.12 |
| Comparative | B | 90 | 0.2 | 11,000 | 24,000 | 1.7 × 10² | −5% | 1.08 | 1.31 |
| Example 1 | | | | | | | | | |
| Comparative | C | 90 | 0.2 | 9,000 | 27,000 | 1.6 × 10² | −1% | 1.10 | 1.32 |
| Example 2 | | | | | | | | | |
| Comparative | D | 120 | 0.2 | 11,000 | 1,900 | 1.6 × 10² | −10% | 0.85 | 1.03 |
| Example 3 | | | | | | | | | |
| Comparative | E | 180 | 0.04 | 8,000 | 1,800 | 1.6 × 10² | −1% | 0.74 | 0.91 |
| Example 4 | | | | | | | | | |
| Comparative | F | 280 | 0.04 | 6,000 | 500 | 1.7 × 10² | −2% | 0.72 | 0.90 |
| Example 5 | | | | | | | | | |

It was apparent from th results that the aqueous pigment dispersions of Examples 1 to 4 have small numbers of coarse particles and good dispersibility and storage stability. In addition, the inks for ink jet recording produced by using the aqueous pigment dispersions of the present invention had high values in the density on the printed surface per unit quantity of ink ejected, which was obtained by dividing (C*/L*) by (Abs.), both on recycled paper and ink jet-dedicated paper.

1. An aqueous pigment dispersion comprising: a pigment including C.I. pigment red 150; a water soluble organic solvent; and a radical polymer having an aromatic ring structure or a heterocyclic structure and having an acid value of 50 to 120 mgKOH/g;
acid groups in the radical polymer being partially or entirely neutralized with a basic compound,
the radical polymer being contained at a mass ratio to the pigment of 0.001 to 0.1.

2. The aqueous pigment dispersion according to claim 1, wherein the radical polymer has a weight average molecular weight in the range of 2,000 to 40,000.

3. A method of producing an aqueous pigment dispersion, the method comprising: producing a kneaded mixture that contains a pigment including C.I. pigment red 150, a basic compound, a water soluble organic solvent, and a radical polymer having an aromatic ring structure or a heterocyclic structure and having an acid value of 50 to 120 mgKOH/g at a mass ratio of the radical polymer to the total amount of the pigment in the range of 0.001 to 0.1; and mixing the kneaded mixture with water.

4. The method of producing an aqueous pigment dispersion according to claim 3, wherein the radical polymer has a weight average molecular weight in the range of 2,000 to 40,000.
